(19) United States
(12) Patent Application Publication
(10) Pub. No.: US 2025/0349920 A1
(43) Pub. Date: Nov. 13, 2025

(54) THERMISTOR BASED THERMAL RUNAWAY DETECTION SYSTEM FOR ELECTRIC VEHICLE

(71) Applicant: Atieva, Inc., Newark, CA (US)

(72) Inventor: Logan Garby, San Francisco, CA (US)

(21) Appl. No.: 18/657,424

(22) Filed: May 7, 2024

(51) Int. Cl. H01M 10/48; H01M 10/42; H01M 10/653; H01M 50/249

(52) U.S. Cl. CPC H01M 10/486; H01M 10/425; H01M 10/482; H01M 10/653; H01M 50/249; H01M 2200/105; H01M 2200/106; H01M 2220/20

(57) ABSTRACT

An electric vehicle includes an electric motor configured for powering the electric vehicle; a battery system configured for supplying power to the electric motor, where the battery system includes a plurality of battery modules; one or more thermistors attached to each battery module, each thermistor configured to measure a temperature of the air around the battery module to which the thermistor is attached; and a controller configured to determine, based on temperatures measured by the one or more thermistors at different times, a rate of change of a temperature of the air around the battery module and configured to generate, in response to a determined rate of change that exceeds a threshold rate of change, a signal.

### TECHNICAL FIELD

This document relates to electric vehicles and, in particular, to thermistor-based thermal runaway detection systems for electric vehicles.

### BACKGROUND

Among different types of automobiles, hybrid and all-electric vehicles (collectively, “electric vehicles”) face unique challenges due to their inclusion of rechargeable batteries. Rechargeable batteries can be relatively unstable and prone to thermal runaway, an event that occurs when a battery's internal reaction rate increases to such an extent that it generates more heat than can be dissipated from the battery. If the reaction rate and generation of heat go unabated, eventually the heat generated becomes great enough to cause the battery and materials in proximity to the battery to combust.

Although thermal runaway events are rare in electric vehicles, they pose a serious threat to occupants of the vehicle, and measures must be taken to quickly detect the occurrence of a thermal runaway event, so that occupants of the vehicle can be warned of the event. Thermal runaway events have been detected with pressure sensors and gas sensors that detect the effect of the thermal runaway event on the air pressure in a battery or that detect the effect of the thermal runaway event on the gas composition in a battery, respectively. However, such approaches can be prone to generating false positive events and/or expensive and may not be able to reliably detect thermal runaway events in batteries having multiple sealed areas.

### SUMMARY

In some aspects, the techniques described herein relate to an electric vehicle that includes: an electric motor configured for powering the electric vehicle; a battery system configured for supplying power to the electric motor, where the battery system includes a plurality of battery modules; one or more thermistors attached to each battery module, each thermistor configured to measure a temperature of the air around the battery module to which the thermistor is attached; and a controller configured to determine, based on temperatures measured by the one or more thermistors at different times, a rate of change of a temperature of the air around the battery module and configured to generate, in response to a determined rate of change that exceeds a threshold rate of change, a signal.

In some aspects, the techniques described herein relate to an electric vehicle, in which each thermistor includes a negative thermal coefficient thermistor.

In some aspects, the techniques described herein relate to an electric vehicle, in which each thermistor includes a positive thermal coefficient thermistor.

In some aspects, the techniques described herein relate to an electric vehicle, in which the battery system includes at least 16 battery modules.

In some aspects, the techniques described herein relate to an electric vehicle, in which the rate of change of the temperature is determined over a time interval of at least one second.

In some aspects, the techniques described herein relate to an electric vehicle, in which two or more thermistors are attached to each battery module.

In some aspects, the techniques described herein relate to an electric vehicle, in which the controller is configured to determine, based on temperatures measured by a first one of the thermistors at different times, a first rate of change of a temperature of the air around the battery module, which exceeds the threshold rate of change and to determine, based on temperatures measured by a second one of the thermistors at different times, a second rate of change of a temperature of the air around the battery module, which exceeds the threshold rate of change, and configured to generate, in response to a determined first and second rates of change, the signal.

In some aspects, the techniques described herein relate to an electric vehicle, further including a plurality of thermistor housings, each thermistor housing containing a thermistor of the thermistors, each thermistor housing including a first portion configured for mechanical attachment to a battery module housing and a second portion configured to position the thermistor contained within the thermistor housing adjacent to an exterior wall the battery module housing when the first portion is mechanically attached to the battery module housing.

In some aspects, the techniques described herein relate to an electric vehicle, further including a polymer material that secures the thermistor contained within the thermistor housing to the second portion of the thermistor housing.

In some aspects, the techniques described herein relate to an electric vehicle, in which the polymer material has a dielectric breakdown voltage of at least 10 kV per millimeter.

In some aspects, the techniques described herein relate to an electric vehicle, in which the polymer material has a thermal conductivity of at least 0.8 W/m-K.

In some aspects, the techniques described herein relate to an electric vehicle, in which the first portion of the thermistor housing includes a first portion of a snap-fit assembly for engaging with a second portion of the snap-fit assembly located on the battery module housing, where the snap-fit mechanically attaches of the thermistor housing to the battery module housing.

In some aspects, the techniques described herein relate to an electric vehicle, in which the threshold rate of change is at least 3° C.

In some aspects, the techniques described herein relate to a method. The method includes coupling a plurality of thermistors to a battery system of an electric vehicle, where the battery system supplies power to an electric motor of the electric vehicle, and where the battery system includes a plurality of battery modules and one or more thermistors of the plurality of thermistors are attached to each battery module. The method further includes measuring, with one or more thermistors attached to battery module, a temperature of air around the battery module to which the one or more thermistors are attached. The method further includes determining, based on temperatures measured by the one or more thermistors at different times, a rate of change of a temperature of the air around the battery module. The method further includes generating, in response to a determined rate of change that exceeds a threshold rate of change, a signal.

In some aspects, the techniques described herein relate to a method in which the rate of change of the temperature is determined over a time interval of at least one second.

In some aspects, the method further includes determining, based on temperatures measured by a first one of the thermistors at different times, a first rate of change of a temperature of the air around the battery module, which exceeds the threshold rate of change; determining, based on temperatures measured by a second one of the thermistors at different times, a second rate of change of a temperature of the air around the battery module, which exceeds the threshold rate of change; and generating, in response to the combination of the determined first and second rates of change, the signal.

### BRIEF DESCRIPTION OF DRAWINGS

FIG. 1 is an example perspective view of a vehicle.

FIG. 2 is an example transparent perspective view of a vehicle that includes a battery system that includes a plurality of individual battery modules that can be supported by the battery enclosure that is connected to the vehicle chassis, for example, below the passenger cabin.

FIG. 3 is a schematic block diagram of an electric vehicle that includes a motor and a battery system.

FIG. 4 is a top view of a battery module housing is configured for housing and containing a battery module of a battery system for an electric vehicle.

FIGS. 5A, 5B, 5C are different perspective views of the battery module housing shown in FIG. 4.

FIG. 6A is a perspective view of a thermistor housing.

FIG. 6B is a top view of the thermistor housing of FIG. 6A.

FIG. 6C is a front view of the thermistor housing of FIG. 6A.

FIG. 7A is a sectional front view of a thermistor module that includes a thermistor in a housing with the thermistor being electrically connected to an electrical connector.

FIG. 7B is a back view of the thermistor module of FIG. 7A.

FIG. 7C is an enlarged view of a portion of the thermistor module, which is shown in the circle of FIG. 7A.

FIG. 8 is a graph of a temperature, and of a change of temperature, measured by a thermistor as a function of time.

FIG. 9 is a graph of different temperature change measurements recorded by a thermistor is a function of different time intervals over which the temperature change measurements were recorded.

FIG. 10 is a graph of a temperature increase during a thermal runaway event, as measured by a thermistor, expressed a percentage of a maximum temperature fluctuation expected during typical operation of a vehicle as a function of the time interval over which the temperature increase is recorded.

Like reference symbols in the various drawings indicate like elements.

### DETAILED DESCRIPTION

As described herein, an electric vehicle can have a battery system that includes a plurality of individual battery modules (e.g., more than 10 modules, more than 16 modules, more than 30 modules, or more than 40 modules), with the individual modules being electrically connected to provide power to components of the electric vehicle including a drive motor of the electric vehicle. One or more thermistors can be attached to each battery module of the battery system, and the thermistors can detect a thermal runaway event in the battery module to which they are attached by measuring an increasing temperature in the air surrounding the thermistors. Each thermistor can be encased in electrically-insulating material that permits the thermistor to operate in a high-voltage environment, such as the environment of an electric vehicle's battery. The electrically-insulating material can have a high thermal conductivity, so that an increase in temperature due to a thermal runaway event can be quickly detected by the thermistor.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger cabin accommodating one or more people.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

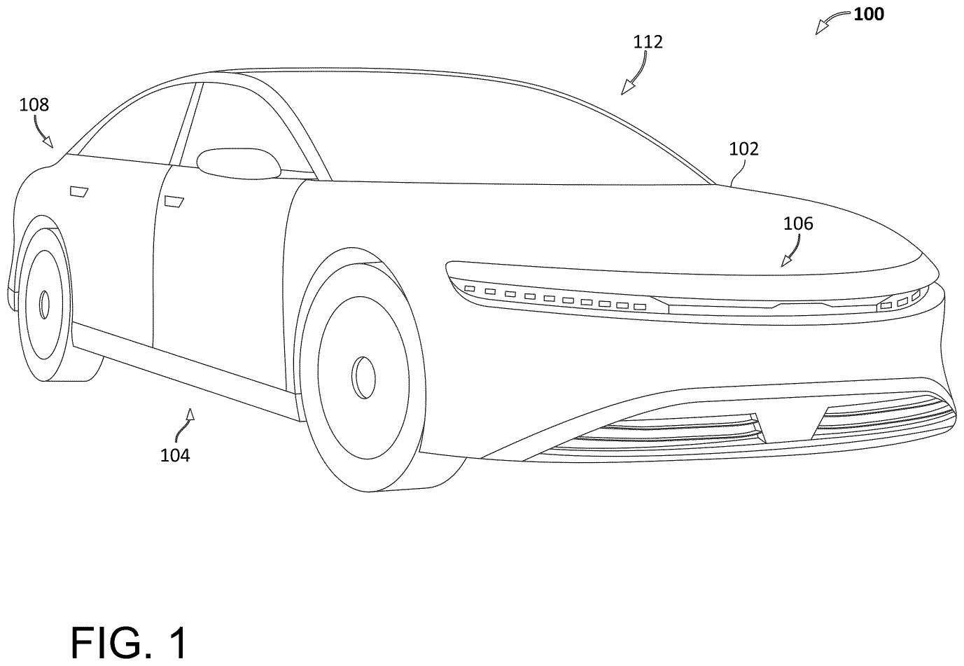

FIG. 1 is an example perspective view of a vehicle 100. The vehicle 100 can be used with one or more other examples described elsewhere herein. The vehicle 100 includes a vehicle body 102 and a vehicle chassis 104 supporting the vehicle body 102. For example, the vehicle body 102 of FIG. 1 is a four-door type of vehicle with room for at least four occupants, and the vehicle chassis 104 has four wheels. Other numbers of doors, wheel counts, vehicle purpose, types of vehicle body 102, and/or kinds of vehicle chassis 104 can be used in some implementations.

The vehicle body 102 has a front 106 and a rear 108 and can have a passenger cabin 112 between the front and the rear. The vehicle 100 can have at least one motor, which can be positioned in one or more locations of the vehicle 100. In some implementations, the motor(s) can be mounted generally near the front 106, generally near the rear 108, or both. A battery system that includes a plurality of individual battery modules can be supported by the vehicle chassis 104, for example, below the passenger cabin and can be used to power the motor(s). The one or more motor(s) can receive electrical power from the battery system and use the power received from the battery to propel the vehicle 100 and to provide accessory and auxiliary features of the vehicle. Thus, the vehicle 100 can be an “electric vehicle,” in that the vehicle can be propelled by energy received from the battery. In some implementations, the electric vehicle and be an all-electric vehicle that does not include an internal combustion engine. In some implementation, the electric vehicle can be a hybrid vehicle that can be propelled by energy received from the battery, energy generated by an internal combustion engine, or a combination of energy received from both the battery and generated by the internal combustion engine.

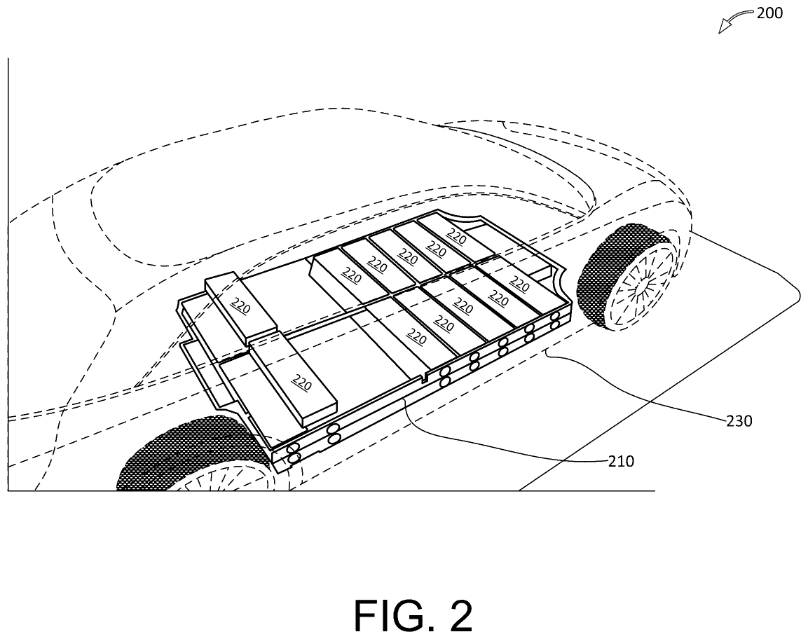

FIG. 2 is an example transparent perspective view of a vehicle 200 that includes a battery system 210 that includes a plurality of individual battery modules 220 that can be supported by the vehicle chassis 230, for example, below the passenger cabin. In some implementations, individual battery modules 220 within the battery system 210 can be sealed off from each other to prevent fluid and gas from one module migrating to another module.

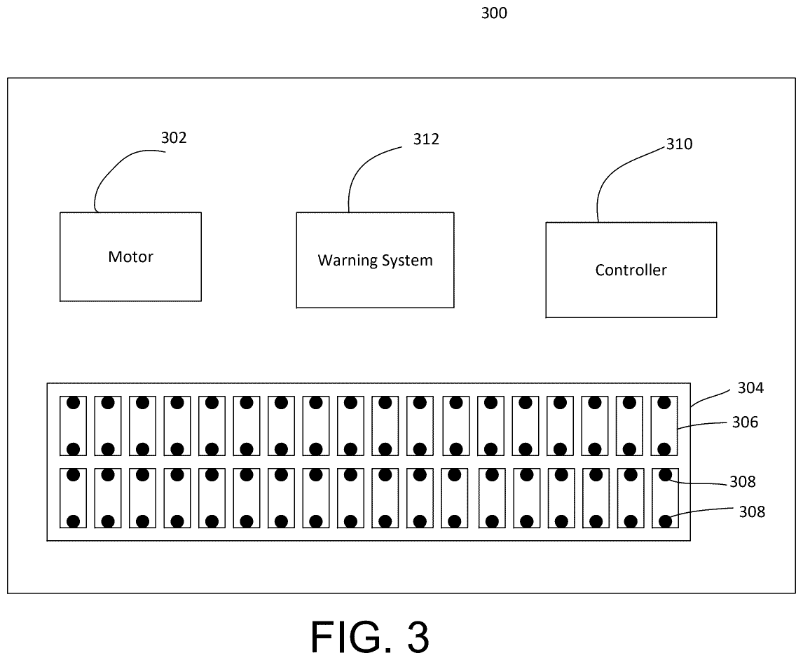

FIG. 3 is a schematic block diagram of an electric vehicle 300 that includes a motor 302 and a battery system 304. The battery system includes a plurality of battery modules 306, and a plurality of thermistors 308 are attached to each battery module 306. The thermistors 308 include a material whose electrical resistance changes strongly as a function of temperature. The thermistors 308 can include negative temperature coefficient (NTC) thermistors, in which the resistance decreases with increasing temperature, and/or positive temperature coefficient (PTC) thermistors, in which the resistance increases with increasing temperature.

The thermistors 308 can detect a change in temperature in the air that surrounds the thermistor, and a sudden change in temperature detected by a thermistor 308 can indicate the existence of a thermal runaway event in the battery module 306 to which the thermistor is attached. Signals generated by the thermistors 308 based on a temperature measured by the thermistors can be provided to a controller 310 that is configured to process the signals to determine the existence of a thermal runaway event in a battery module 306. When a thermal runaway event is detected, the controller 310 can provide a signal to a warning system 312 that can provide a warning to occupants of the vehicle 300. For example, the warning system 312 can provide audio, visual, graphical, and/or tactile warnings to the occupants of the vehicle about a critical failure within the vehicle and can inform the occupants that the occupants need to stop and exit the vehicle within a predetermined time (e.g., within 10 seconds).

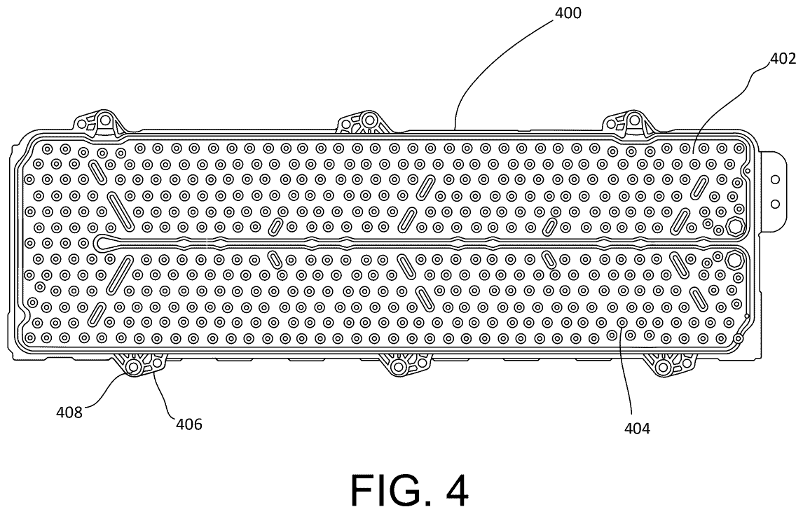

FIG. 4 is a top view of a battery module housing 400 that is configured for housing and containing a battery module for an electric vehicle. The battery module housing 400 includes a bottom wall 402 that can include a liquid cooling plate having a plurality of dimples 404 that create turbulent flow as coolant flows over the plate 402 and that cools the battery contained within the battery module housing 400. The battery module housing 400 also includes a number of structural features that can be used for attaching the housing to other housings of the battery system or to other components of the battery system of the electric vehicle. For example, the battery module housing 400 can include one or more tabs 406 that include attachment points 408 that can attach the housing to another housing.

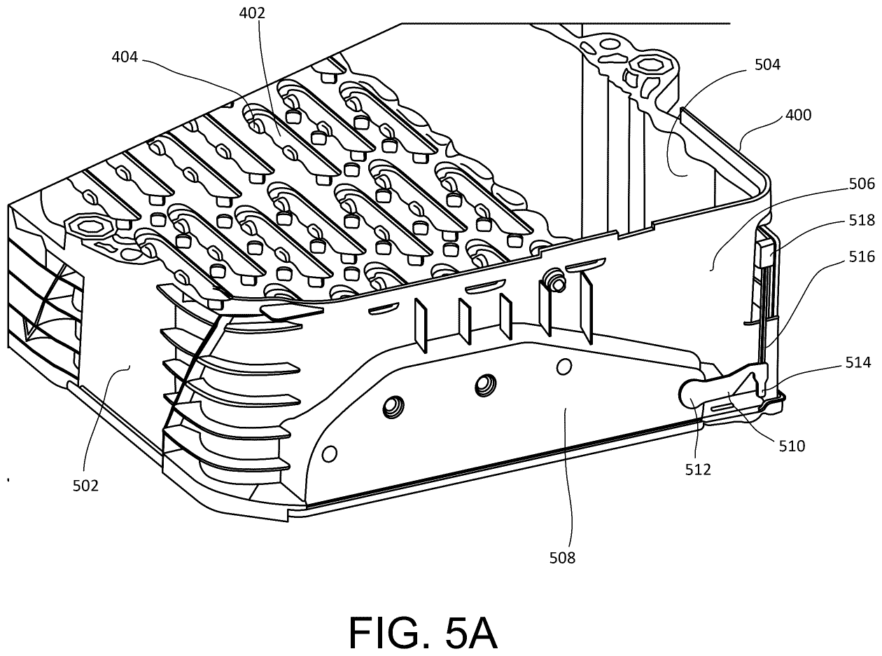

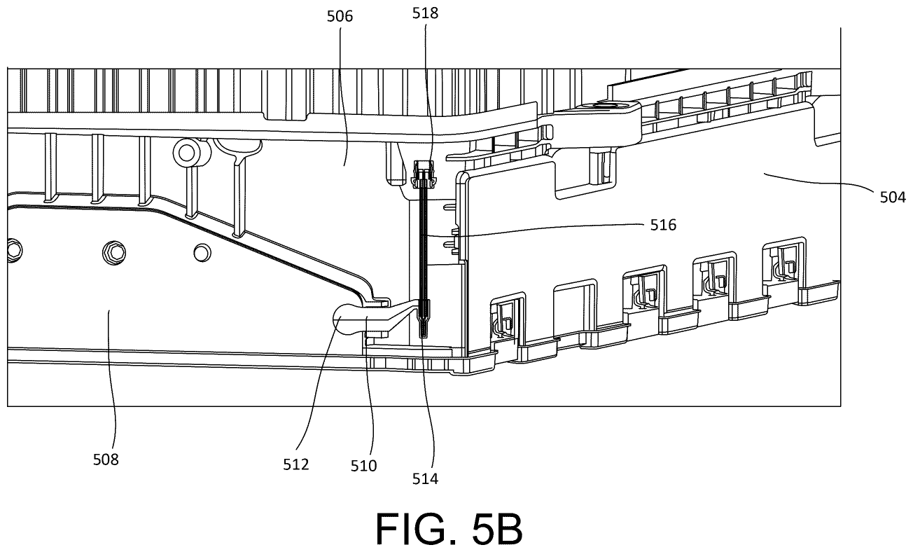

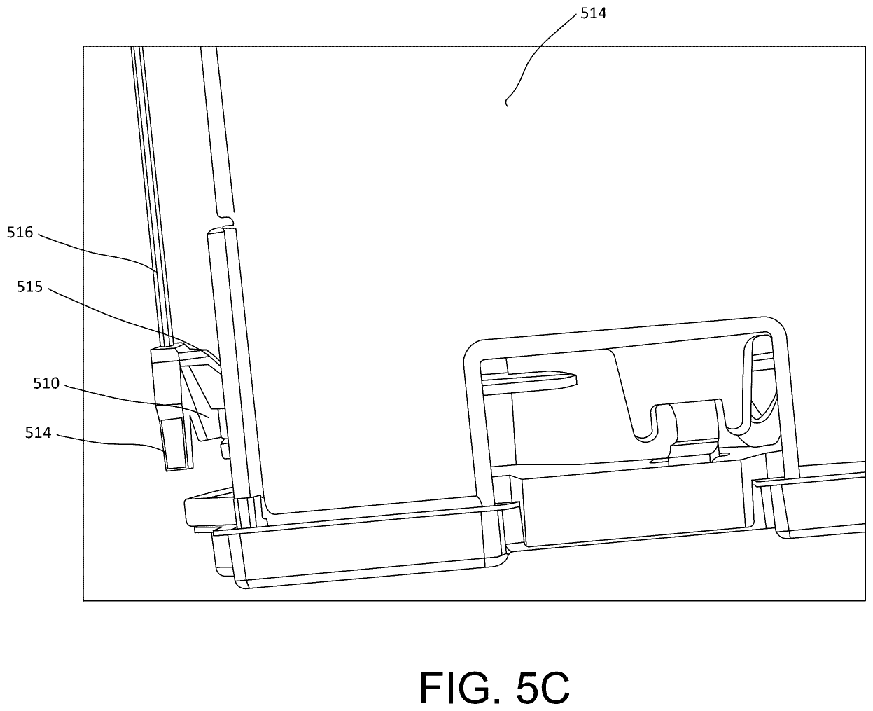

FIGS. 5A, 5B, 5C are different perspective views of the battery module housing 400 shown in FIG. 4. The battery module housing 400 can include sidewalls 502, 504 and end walls 506 that, together with the bottom wall 402 and a top wall (not shown), can enclose a battery within the battery module housing. One or more walls 402, 502, 504 of the battery module housing 400 can be formed of a plastic material, for example, a polycarbonate material, and can include a plurality features (e.g., dimples) that aid in cooling a battery located within the housing. In some implementations, a metal busbar 508 can be included with, or attached to, the battery module housing 400 and can provide for electrical connections between a battery within the housing and one or more electrical components located outside the housing.

A thermistor module 510 can be attached to the battery module housing 400 and can be used to measure a temperature close to the housing. The thermistor module 510 can include a thermistor housing having a first portion 512 that is configured for mechanical attachment to the battery housing 400 and a second portion 514 that is configured to position a thermistor contained within the thermistor housing in proximity with the battery module housing. For example, when the thermistor module 510 is attached to the battery module housing 400, a thermistor contained within the second portion 514 can be positioned adjacent to an exterior wall of the battery module housing 400, so that the thermistor can measure a temperature (e.g., a fluid temperature, such as, for example, an air temperature or a liquid temperature) of a substance that is in close proximity to the battery module housing. The housing of the thermistor module 510 can include a standoff portion 515 that provides stiffness to the housing to limit rotation about the point of attachment to the battery module housing 400 and that maintains a predetermined minimum distance between the second portion 514 of the housing and an exterior wall of the battery module housing 400. A sudden change in the temperature measured by the thermistor can indicate a thermal runaway event of a battery contained within the battery module housing 400.

The thermistor contained within the thermistor module 510 can generate a signal in response to a temperature of the thermistor, and the signal can be transmitted along one or more electrical conductors (e.g., wires) 516 to an electrical connector 518. The electrical connector can provide a connection to one or more other components of the electric vehicle, for example, a printed circuit board of a controller that can process signals from the thermistor and generate resulting signals in response to the signals from the thermistor.

The thermistor module 510 can be configured to have a relatively high thermal conductivity between the fluid (e.g., gas or liquid) surrounding the module and a thermistor contained within the module. For example, walls of the second portion 514 of the thermistor module 510 can be relatively thin, for example, less than or equal to 0.5 mm, to provide for a relatively high conductivity of heat through the walls.

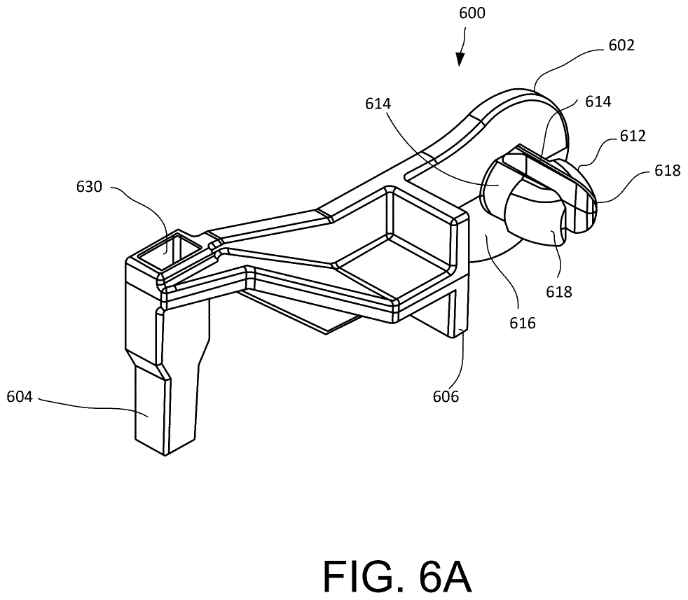

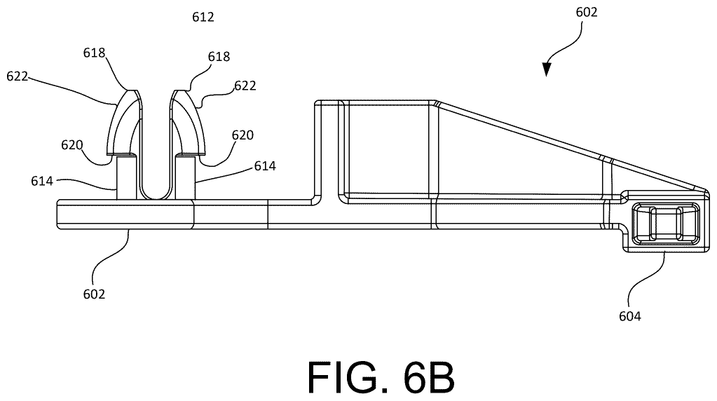

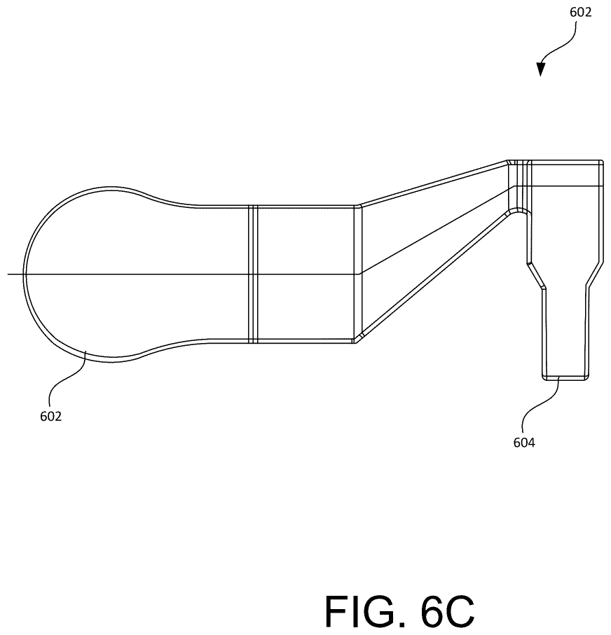

FIG. 6A is a perspective view of a thermistor housing 600. FIG. 6B is a top view of the thermistor housing 600 of FIG. 6A. FIG. 6C is a front view of the thermistor housing 600 of FIG. 6A.

The thermistor housing 600 can be formed of one or more pieces. In an example implementation, the thermistor housing 600 can be an injection molded plastic (e.g. polycarbonate) part. The thermistor housing 600 includes a first portion 602 that is configured to mechanically attach the housing to a battery module and a second portion 604 that is configured to position a thermistor contained within the housing adjacent to an exterior wall of the battery module.

The first portion 602 can include a first part 612 of a snap-fit assembly that can engage with the second part of the snap-fit assembly, which can be located in, or on, the battery module, such that the snap-fit assembly can be used to mechanically attach the thermistor housing 600 to the battery module. In one implementation, the first part 612 of the snap-fit assembly can include one or more legs 614 that extend away from a rear surface 616 of the first portion 602 of the thermistor housing 600. Ends of the legs that are distal to the rear surface 616 can include heads 618, which have flat tabs 620 that are substantially parallel to the rear surface 616. The heads 618 can have a curved surface 622 that extends away from an axis of the legs, where the axis is perpendicular to the rear surface 616, and where the curved surface 622 can be closer to the axis at the distal and of the head than at a proximal end of the head that connects the surface to the flat tabs 620 of the head. The material and the dimensions of the legs 614 can be selected such that the legs can bend in response to forces generated by a human finger, and then when the legs are inserted into a hole in the battery housing, the heads of the legs can bend inward towards each other to allow the legs 614 to fit into the hole and then, once the legs have been inserted beyond a threshold distance greater than the length of the heads, the heads can spring outward away from each other, such that the flat tabs 620 can engage with a surface within the hole of the battery housing to securely attach the thermistor housing 600 to the battery module.

The second portion 604 of the thermistor housing 600 can include a cavity that is open at one end. A hole 630 at the open end of the cavity allows the thermistor to be placed inside the cavity. As explained above, the portion of the thermistor housing 600 that forms the cavity can be configured to have a relatively high thermal conductivity. For example, walls of cavity can be relatively thin, for example, less than or equal to 0.5 mm, to provide for a relatively high conductivity of heat through the walls.

In addition to the legs 614 of the first part of the snap-fit assembly, a standoff member 606 can extend away from the rear surface 616 of the thermistor housing 600. The standoff member 606 can be configured in relation to the cavity formed in the second portion 604 of the thermistor housing and in relation to the legs 614 of the first portion 602, so that when the thermistor housing 600 is mechanically attached to the battery module (e.g., by way of the legs 614 that form the first part of the snap-fit assembly) the standoff member 606 provides stiffness to the thermistor housing 600 and maintains the cavity of the thermistor housing at a predetermined distance away from the battery module.

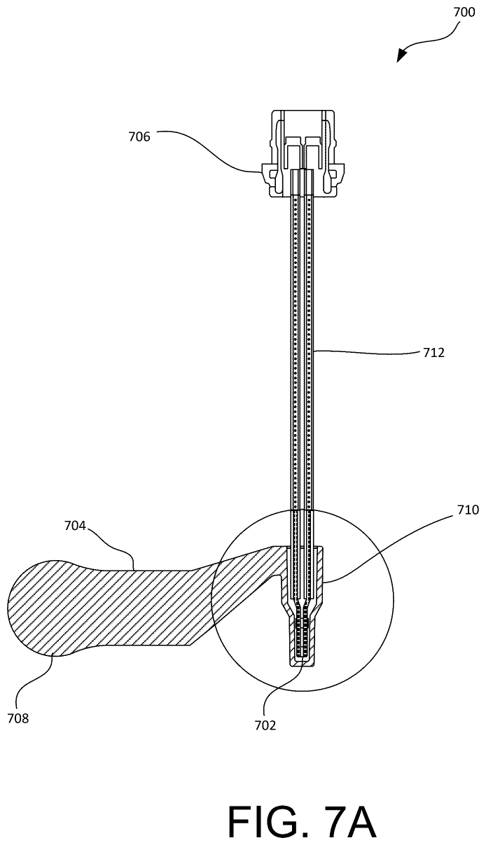

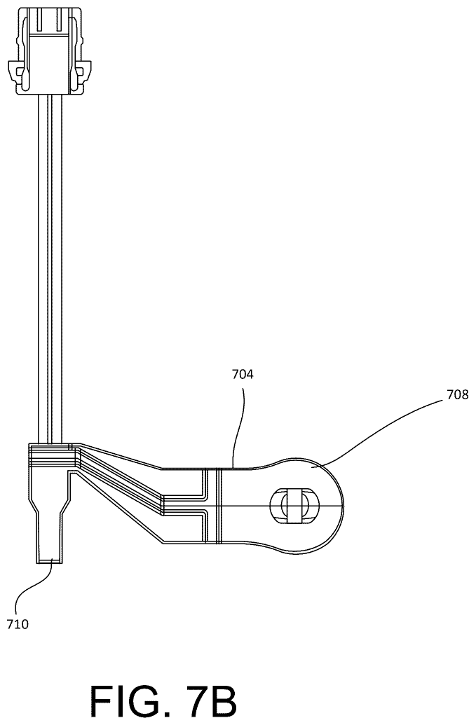

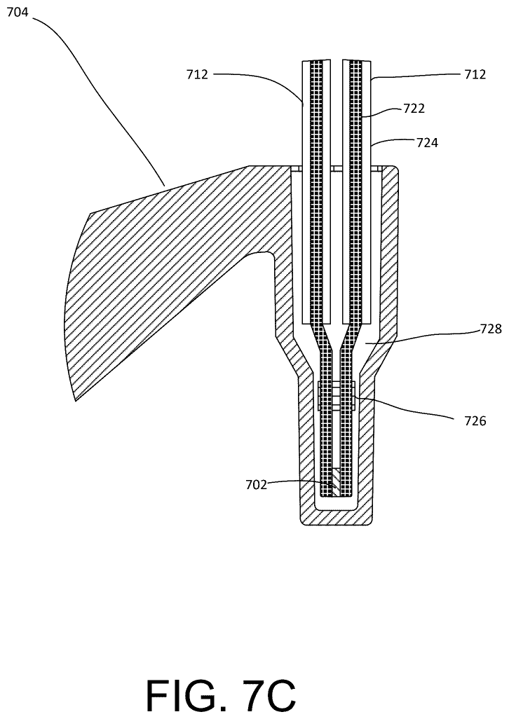

FIG. 7A is a sectional front view of a thermistor module 700 that includes a thermistor in a housing with the thermistor being electrically connected to an electrical connector 706. FIG. 7B is a back view of the thermistor module of FIG. 7A. FIG. 7C is an enlarged view of a portion of the thermistor module, which is shown in the circle of FIG. 7A. As explained above, the thermistor housing 704 includes the first portion 708 that is configured for mechanically attaching the housing to a battery module and a second portion 710 that is configured for containing a thermistor 702 and positioning the thermistor in relation to the battery module, so that the thermistor can measure a temperature in the vicinity of the battery module. The thermistor 702 can be located near the bottom of a cavity formed in the first portion 708 of the thermistor housing 704. The thermistor 702 can be electrically connected to an electrical connector 706 by one or more electrical conductors (e.g., wires) 712, and the electrical connector 706 can form a connection to other electrical components that make use of the functionality of the thermistor module 700.

The electrical conductors 712 to which the thermistor 702 is connected can include an inner conductive portion 722 that is surrounded by an insulating sheath 724. With the insulating sheath 724 in place, the electrical conductors 712 can be used in a high-voltage environment, such as may be found within a battery system of an electric vehicle. For example, the electrical conductors can be rated for use up to at least 900 V DC and to withstand voltages of up to at least 4 kV for a period of two seconds without damage or short circuiting.

The sheath of the electrical connectors can be stripped from the portions of the electrical connectors close to the thermistor 702. One or more insulating spacers 726 can be used to position the conductive portions 722 of the conductors 712 that are close to the thermistor 702 within the cavity of the thermistor housing 704 and to ensure that the conductive portions of different conductors do not touch or short.

The thermistor 702 and the portions of the electrical conductors that are stripped of their sheaths can be secured within the cavity of the thermistor housing 704 by a polymer material 728. The polymer material can include, for example, an epoxy material that can be introduced into the cavity before it is set, and then it can be cured within the cavity into a hardened state to secure the thermistor 702 into position. In some implementations, the polymer material has a dielectric breakdown voltage of at least 10 kV per millimeter, and the dimensions of the cavity of the thermistor housing can be selected, such that when the thermistor 702 is secured within the cavity by the polymer material that a thickness of the polymer layer around the thermistor is sufficient to ensure that the thermistor can withstand a voltage of at least 1000 V DC outside the cavity without damage to the thermistor. In addition, the polymer material can have a thermal conductivity of at least 0.8 W/m-K, and the dimensions of the cavity can be selected, such that when the thermistor 702 is secured within the cavity by the polymer material a sudden temperature change in the fluid around the cavity due to a thermal runaway event in the battery module can be detected by the thermistor within one second.

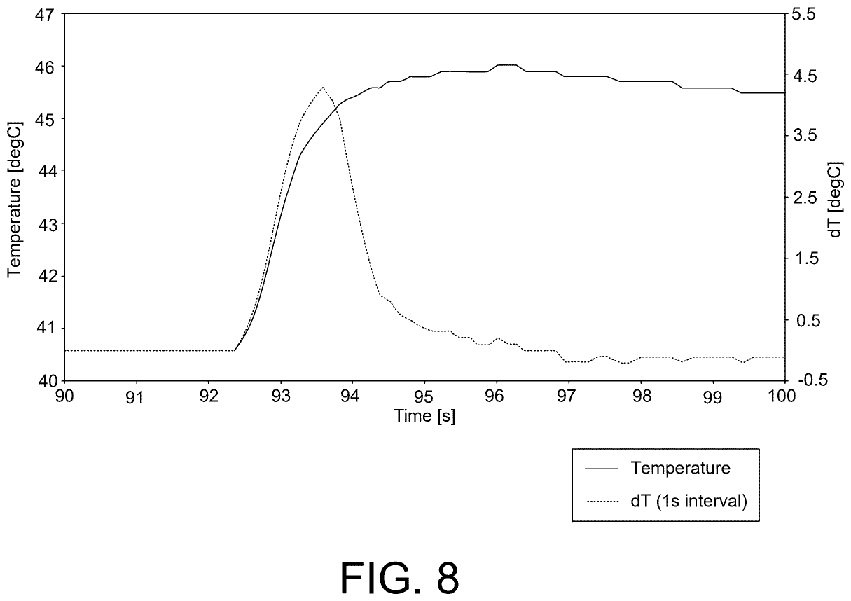

FIG. 8 is a graph of a temperature (solid line, left-hand scale), and of a change of temperature (dotted line, right-hand scale), measured by a thermistor as a function of time during a thermal runaway event in which the temperature measured at the thermistor rises from 40.5° C. to 46° C. The change of temperature value at a given time in the graph of FIG. 8 is the difference between the temperature at that time and the temperature measured one second before the time. In some implementations, the controller 310 can temperature measurements from a thermistor at different times and store at least two temperature measurements, from which the change in temperature value can be calculated. The time interval over which a change of temperature is measured (e.g., one second, as used in the graph of FIG. 8) can affect the maximum value measured for the change of temperature. For example, a very short time interval may result in a low value of the change in temperature value. A very long time interval may result in a change in temperature value for a thermal runaway event that is difficult to distinguish from typical fluctuations of the temperature that are not caused by a thermal runaway event.

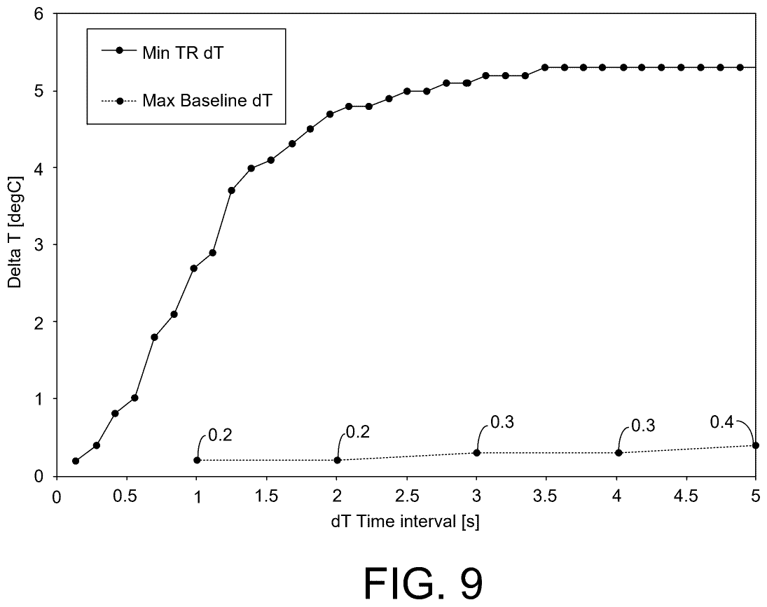

FIG. 9 is a graph of different temperature change measurements caused by a thermal runaway event (solid line) and temperature change measurements caused by typical fluctuations of the temperature near a battery module (dotted line), which are recorded by a thermistor as a function of different time intervals over which the temperature change measurements were recorded. The data graphed in FIG. 9 are experimental data recorded for a number of events, and the data for the temperature change measurements caused by a thermal runaway event represent the minimum observed temperature changes caused by a thermal runaway event for a particular time interval, while the data for the temperature change measurements caused by typical temperature fluctuations represent the maximum observed temperature changes caused for a particular time interval. As seen in FIG. 9, the temperature changes due to typical fluctuations increase for increasing time intervals, while the temperature changes due to thermal runaway events increase quickly for time intervals below two second and then increase slowly, until plateauing at time intervals above 3.5 seconds. For a particular time interval, a ratio between the temperature change value due to a thermal runaway event and a temperature change value due to typical temperature fluctuations can provide a quality metric to evaluate the utility of using a particular time interval over which to measure a temperature change for the purpose of distinguishing a thermal runaway event in a battery module from a normal operation of the battery module.

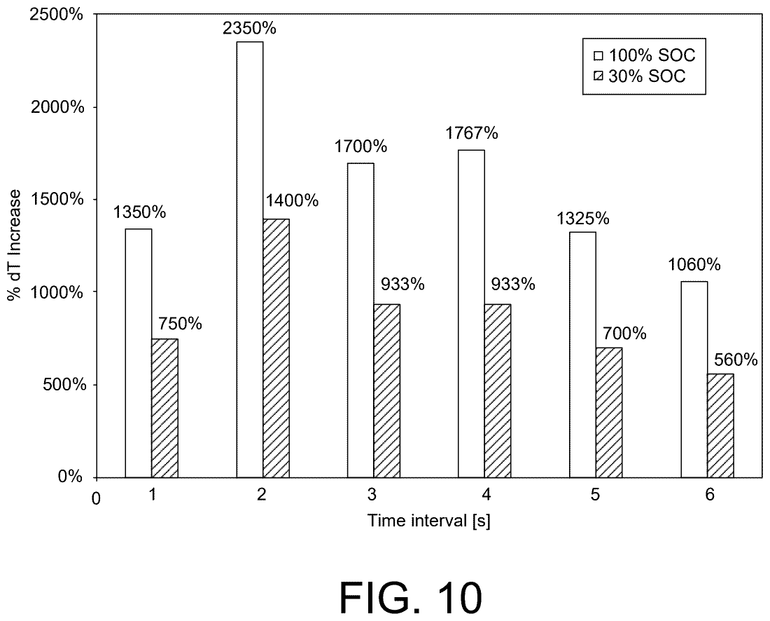

FIG. 10 is a graph of a ratio between a temperature change value due to a thermal runaway event and a temperature change value due to typical temperature fluctuations for different time intervals over which the temperature changes are measured. For each time interval (i.e., 1 second, 2 seconds 3 seconds, 4 seconds, 5 seconds, and 6 seconds), an unfilled bar indicates the value of the ratio for batteries that are charged to 100% of their charge capacity and a striped bar indicates the value of the ratio for batteries that are charged to 30% of their charge capacity. As seen in FIG. 10, the 2 second time interval provides the highest values of the ratio, both for batteries charged to 100% of their charge capacity and for batteries charged to 30% of their charge capacity. Thus, based on the data shown in FIG. 10, a two second time interval for measuring a temperature change can provide the highest degree of discrimination between a temperature change caused by a thermal runaway event and a temperature change caused by a typical fluctuation. Therefore, to reliably detect a thermal runaway event based on a change in temperature measured by a thermistor, a time interval over which the temperature change is measured can be selected to be provide high discrimination of the thermal runaway event from a typical temperature fluctuation. Furthermore, the thermal runaway event can be determined by a temperature change over the time interval that exceeds a threshold value, where the threshold value may be a predetermined minimum temperature change (e.g., 3° C.), or a percentage (e.g., 1000%) of a typically expected temperature fluctuation over the time interval, etc.

Referring again to FIG. 3, one or more thermistors 308 can measure temperatures in the air that surrounds the thermistor at different times, and the temperature measurements can be provided to the controller 310 that can process the temperature measurements to determine the existence of a thermal runaway event in the battery module 306 to which the thermistor is attached. In some implementations, a temperature change measured by a thermistor attached to a battery module, which exceeds a threshold value, can cause the controller to output a signal indicating a thermal runaway event in the battery module. In some implementations, the controller may output a signal indicating a thermal runaway event in the battery module only if a temperature change exceeding the threshold value is measured by two or more thermistors attached to a battery module. The requirement that two or more thermistors must independently measure a temperature change exceeding the threshold value for the controller to determine a thermal runaway event can reduce the chance of false positive signals of a thermal runaway event being produced by the controller.

The terms “substantially” and “about” used throughout this specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An electric vehicle comprising:
an electric motor configured for powering the electric vehicle;
a battery system configured for supplying power to the electric motor, wherein the battery system includes a plurality of battery modules;
one or more thermistors attached to each battery module, each thermistor configured to measure a temperature of air around the battery module to which the thermistor is attached; and
a controller configured to determine, based on temperatures measured by the one or more thermistors at different times, a rate of change of a temperature of the air around the battery module and configured to generate, in response to a determined rate of change that exceeds a threshold rate of change, a signal.

2. The electric vehicle of claim 1, wherein each thermistor includes a negative thermal coefficient thermistor.

3. The electric vehicle of claim 1, wherein each thermistor includes a positive thermal coefficient thermistor.

4. The electric vehicle of claim 1, wherein the battery system includes at least 16 battery modules.

5. The electric vehicle of claim 1, wherein the rate of change of the temperature is determined over a time interval of at least one second.

6. The electric vehicle of claim 1, wherein two or more thermistors are attached to each battery module.

7. The electric vehicle of claim 6, wherein the controller is configured to determine, based on temperatures measured by a first one of the thermistors at different times, a first rate of change of a temperature of the air around the battery module, which exceeds the threshold rate of change and to determine, based on temperatures measured by a second one of the thermistors at different times, a second rate of change of a temperature of the air around the battery module, which exceeds the threshold rate of change, and configured to generate, in response to a determined first and second rates of change, the signal.

8. The electric vehicle of claim 1, further comprising a plurality of thermistor housings, each thermistor housing containing a thermistor of the thermistors, each thermistor housing including a first portion configured for mechanical attachment to a battery module housing and a second portion configured to position the thermistor contained within the thermistor housing adjacent to an exterior wall the battery module housing when the first portion is mechanically attached to the battery module housing.

9. The electric vehicle of claim 8, further comprising a polymer material that secures the thermistor contained within the thermistor housing to the second portion of the thermistor housing.

10. The electric vehicle of claim 9, wherein the polymer material has a dielectric breakdown voltage of at least 10 kV per millimeter.

11. The electric vehicle of claim 9, wherein the polymer material has a thermal conductivity of at least 0.8 W/m-K.

12. The electric vehicle of claim 8, wherein the first portion of the thermistor housing includes a first portion of a snap-fit assembly for engaging with a second portion of the snap-fit assembly located on the battery module housing, wherein the snap-fit mechanically attaches the thermistor housing to the battery module housing.

13. The electric vehicle of claim 1, wherein the threshold rate of change is at least 3° C.

14. A method comprising:
attaching a plurality of thermistors to a battery system of an electric vehicle, wherein the battery system supplies power to an electric motor of the electric vehicle, wherein the battery system includes a plurality of battery modules and one or more thermistors of the plurality of thermistors are attached to each battery module;
measuring, with one or more thermistors attached to battery module, a temperature of air around the battery module to which the one or more thermistors are attached;
determining, based on temperatures measured by the one or more thermistors at different times, a rate of change of a temperature of the air around the battery module; and
generating, in response to a determined rate of change that exceeds a threshold rate of change, a signal.

15. The method of claim 14, wherein the rate of change of the temperature is determined over a time interval of at least one second.

16. The method of claim 14, further comprising:
determining, based on temperatures measured by a first one of the thermistors at different times, a first rate of change of a temperature of the air around the battery module, which exceeds the threshold rate of change;
determining, based on temperatures measured by a second one of the thermistors at different times, a second rate of change of a temperature of the air around the battery module, which exceeds the threshold rate of change; and
generating, in response to a combination of the determined first and second rates of change, the signal.
